(19) United States
(12) Patent Application Publication
(10) Pub. No.: US 2007/0009643 A1
(43) Pub. Date: Jan. 11, 2007

(54) Monoglyceride and emulsifier compositions and processes of producing the same

(76) Inventors: Shireen S. Baseeth, Decatur, IL (US); Charles A. Morris, Overland Park, KS (US); John P. Neddersen, Assumption, IL (US); Bruce R. Sebree, Oakley, IL (US); Huey L. Willis, Raymore, MO (US)

Correspondence Address: KIRKPATRICK & LOCKHART NICHOLSON GRAHAM LLP;HENRY W. OLIVER BUILDING, 535 SMITHFIELD STREET, PITTSBURGH, PA, 15222, US

(21) Appl. No.: 11/482,645

(22) Filed: Jul. 7, 2006

Related U.S. Application Data
(60) Provisional application No. 60/697,096, filed on Jul. 7, 2005.

(51) Int. Cl. A23D 9/00

(52) U.S. Cl. 426/601

(57) ABSTRACT

Provided herein are monoglyceride and emulsifier compositions and processes for producing them. The monoglyceride and emulsifier compositions are useful as additives in baked goods, to maintain a soft crumb during storage and to retard staling.

### CROSS-REFERENCE TO RELATED APPLICATION

This application claims the benefit of U.S. Provisional Application No. 60/697,096, filed on Jul. 7, 2005, the entire teachings of which are incorporated herein by reference.

### FIELD OF THE INVENTION

The invention relates to an additive for use in baked goods, to retard staleness, and to improve crumb texture over time.

### BACKGROUND

Staling of baked goods is generally defined as an increase in crumb firmness and a corresponding loss in product freshness. Flavor, aroma, texture, perceived moisture level, and other product characteristics are also negatively affected as staling proceeds. The staling process begins as soon as baking is complete. Amylopectin remains mostly in the starch granule and retrogrades slowly during product storage. Retrogradation occurs by intermolecular and intramolecular association of linear segments, and to a lesser extent between amylopectin and amylose at the interface of the starch granules and the interstitial volume. As amylopectin retrogradation proceeds, a three-dimensional crystalline structure is formed slowly, causing an increase in firmness, or staling.

Factors that control the rate of staling include time, temperature, moisture level, and the presence of additives such as emulsifiers (crumb softeners). The rate of staling shows a linear response with time, but can be minimized by maintaining the maximum allowable moisture in the product or by storage at warm (room temperature or higher) or cold (below freezing) temperatures. Refrigeration enhances staling since the rate of retrogradation is optimal at cold temperatures just above freezing.

Staling eventually causes a product to become unacceptable at the retail or consumer level. It is estimated that 3-5% of all baked goods produced in the United States are discarded due to a loss in freshness. The value of discarded baked goods has been estimated to exceed $1 billion annually in the U.S. alone.

Highly saturated distilled monoglycerides are the most effective commercial stale retarding emulsifiers. These crumb softening emulsifiers are added to bread and other baked goods to complex with starch to soften the crumb and retard the staling caused by starch retrogradation during storage. However, the highly saturated monoglycerides are often solid at room temperature, and are not amenable to automation. Some formulations are in a powder or a bead form, but these are difficult to disperse properly into the dough.

Thus, a need exists for an emulsifier that helps retard staling and that may be readily dispersed into foodstuffs.

### SUMMARY OF THE INVENTION

In one embodiment, a method is provided for making emulsifier compositions, where the emulsifier compositions are fluid in final form. The emulsifier composition can be used in baking to retard staleness and improve crumb texture. In other embodiments, the emulsifier compositions may be used in icings, ice cream, vegetable-based spreads and whipped toppings, margarine, mashed potatoes and beverages. Other food products, such as oil-based emulsions (e.g., non-dairy coffee creamer) may also benefit from being made by the methods described herein. The emulsifier compositions of the present invention are in contrast to commercially-available monoglyceride compositions, which are generally in the form of pastes, powders or beads.

Monoglyceride compositions are also disclosed.

Also provided is a method for making monoglyceride compositions, where the compositions are fluid in final form. The monoglyceride composition can be used in baking to retard staleness and improve crumb texture. The monoglyceride compositions of the present invention are in contrast to commercially-available monoglyceride compositions, which are generally in the form of pastes, powders or beads.

In another embodiment, a process for producing a monoglyceride composition is provided. The process comprises combining water, a monoglyceride and an emulsifier, thus forming a mixture. The mixture is subjected to shearing and/or homogenizing, thus producing a monoglyceride composition.

Also disclosed is a gel-like monoglyceride composition that provides aeration and/or foam-building properties in food products into which the gel-like monoglyceride composition is incorporated. Such foods may include those that benefit from aeration, such as, but not limited to, icings, ice cream, vegetable-based spreads and whipped toppings, margarine, mashed potatoes and beverages. Other food products, such as oil-based emulsions (e.g., non-dairy coffee creamer) may also benefit from being made by the methods described herein.

In one embodiment, the invention includes a process of making a monoglyceride composition. The process includes combining water and a monoglyceride to provide a combination, and subjecting the combination to shearing and/or homogenizing, thus producing a monoglyceride composition. The process can also include optionally storing the monoglyceride composition. The process may also include combining a microbial growth inhibitor with the water, optionally combining an emulsifier with the monoglyceride, optionally melting the monoglyceride, optionally melting the emulsifier, optionally cooling the combination before the combination is sheared and/or homogenized, optionally cooling the mixture and/or optionally milling the mixture. In one embodiment, the homogenizing can be done with a scraped-surface heat exchanger or an ultrasonic cavitation homogenizer. In one embodiment, the water and the monoglyceride can be at a temperature of between about 50° F. and about 200° F. in the process. The water can be provided in an amount necessary to produce a combination that is about 10% to about 95% water by weight. The monoglyceride may be provided in an amount necessary to produce a combination that is about 5% to about 90% monoglyceride by weight. The emulsifier can be selected from the group consisting of diglycerides, diacetyl tartaric acid esters of monoglycerides, ethoxylated monoglycerides, ethoxylated diglycerides, lecithin, acetylated lecithin, hydroxylated lecithin, enzyme modified lecithin, fatty acid salts of lactylates, acids of lactylates, polyglycerol esters, propylene glycol monoesters, polyglycerol esters, sucrose esters, polyglycerol polyricinolate, propylene glycol monoesters, polysorbates, sorbitan esters, and combinations of any thereof.

The invention also includes a monoglyceride composition produced by any of these processes.

In another embodiment, the invention also include a composition that includes water, a monoglyceride, and an emulsifier, where the water, the monoglyceride and the emulsifier are present in the composition in such amounts to confer a viscosity of 67,200 centipoise or less to the composition. In a further embodiment, the water, monoglyceride, and the emulsifier can also be present in the composition in such amounts to confer a viscosity of 30,000 centipoise or less to the composition, or a viscosity of 10,000 centipoise or less to the composition. The emulsifier can be selected from the group consisting of: diglycerides, diacetyl tartaric acid esters of monoglycerides, ethoxylated monoglycerides, ethoxylated diglycerides, lecithin, acetylated lecithin, hydroxylated lecithin, enzyme modified lecithin, fatty acid salts of lactylates, acids of lactylates, polyglycerol esters, propylene glycol monoesters, polyglycerol esters, sucrose esters, polyglycerol polyricinolate, propylene glycol monoesters, polysorbates, sorbitan esters, and combinations of any thereof. The composition can also include a microbial growth inhibitor. The microbial growth inhibitor can be selected from the group consisting of acetic acid, propionic acid, lactic acid, citric acid, a benzoate compound, and combinations of any thereof.

In another embodiment, the compositions described herein can include another emulsifier (e.g., a polysorbate, a lecithin, or any combination thereof), and a microbial growth inhibitor of an organic acid. The composition can also include sodium stearoyl lactylate.

The invention also includes a food composition comprising the composition as described herein. The food composition can be bread, rolls, buns, pizza crust, pretzels, tortillas, pita bread, cakes, cookies, biscuits, crackers, pie crusts, crisp bread, dough, whipped topping. icing, ice cream, vegetable-based spread, margarine, mashed potatoes, dehydrated potatoes, a beverage, or non-dairy creamer.

In one embodiment, the invention includes a process of making a monoglyceride composition, where the process includes: providing water at between about 100° F. and about 200° F., providing a monoglyceride at between about 100° F. and about 200° F., combining the water and the monoglyceride in amounts necessary to produce a mixture that is about 60% to about 95% water and about 5% to about 40% monoglyceride by weight, cooling the mixture to between about 100° F. to about 150° F., milling the mixture, optionally cooling the mixture to between about 50° F. to about 100° F., optionally milling the mixture, and storing the mixture, thus producing a monoglyceride composition. The water may be heated to about 180° F. and the monoglyceride may be heated to about 175° F. The mixture may also be cooled to about 130° F. The cooling may be done in a heat exchanger. The mixture may be milled with a colloid mill, which may be operating at about 7000 rpm. The mixture may further be cooled to about 90° F. The cooling may be done in a heat exchanger. The mixture may be milled in a pin worker, which may be operating at about 125 rpm. The method may include the act of before storing the composition, agitating the composition for about one-half hour to about four hours. The mixture may also be stored at a temperature of from about 40° F. to about 100° F. The mixture may be stored at a temperature of about 72° F.

In another embodiment, the invention includes a process of making a monoglyceride composition, the process comprising: providing water in an amount from about 70% to about 75% by weight, providing a monoglyceride in an amount from about 20% to about 25% by weight, providing polysorbate 60 in an amount from about 1% to about 4% by weight, providing lecithin in an amount from about 1% to about 4% by weight, providing acetic acid in an amount from about 0.1% to about 2% by weight, and providing propionic acid in an amount from about 0.1% to about 2% by weight. The water, acetic acid and propionic acid are combined and heated to between about 100° F. and about 200° F. to form a first combination. The monoglyceride, polysorbate 60 and lecithin are combined and heated to between about 100° F. and about 200° F. to produce a second combination. The first combination and the second combination are combined to produce a mixture, which may be cooled to between about 100° F. to about 150° F. The mixture may also be cooled, and, optionally milled at between about 50° F. to about 100° F. The mixture may also be stored for at least five days, thus producing a monoglyceride composition. The water may be heated to about 180° F. while the monoglyceride may be heated to about 175° F. The mixture may be cooled to about 130° F. and may be done in a heat exchanger. The mixture may be milled with a colloid mill, which may be operating at about 7000 rpm. The mixture also be cooled to about 90° F. in a heat exchanger. The mixture may be milled in a pin worker operating at about 125 rpm. The process may include the additional act of agitating the composition for about one-half hour to about four hours. The mixture may be stored at a temperature of from about 40° F. to about 100° F. The mixture may be stored at a temperature of about 72° F. The mixture may contain about 73% water and may contain about 22.5% monoglyceride. The mixture may also contain about 2% polysorbate 60, about 2% lecithin, about 0.25% acetic acid and/or about 0.25% propionic acid.

Other embodiments include monoglyceride compositions made by the processes described herein.

Also included is a monoglyceride composition that includes monoglyceride in amounts from about 5% to about 40% by weight and water in amounts from about 40% to about 90% by weight and/or polysorbate 60 in about 0% to about 10% by weight, in uniform combination. In one embodiment, the composition may contain about 73% water by weight, about 22.5% monoglyceride by weight, about 0% to about 10% polysorbate 60. In another embodiment, the monoglyceride composition may contain about 0% to about 10% lecithin by weight, or about 2% lecithin by weight. The monoglyceride composition may also include from about 0% to about 5% acetic acid by weight. The monoglyceride composition may also include from about 0% to about 5% propionic acid by weight. The monoglyceride composition may further include from about 0% to about 20% PGME by weight.

In an embodiment, the invention includes a monoglyceride composition comprising in uniform combination: about 22.5% monoglyceride by weight, about 2% polysorbate 60 by weight, about 2% lecithin by weight, about 0.25% acetic acid by weight, about 0.25% propionic acid by weight, and about 73% water by weight.

Other embodiments include food products containing any of the fluid monoglyceride compositions described herein, or any of the monoglyceride compositions made by the processes described herein. The food product may be bread, rolls, buns, pizza crust, pretzels, tortillas, pita bread, cakes, cookies, biscuits, crackers, pie crusts, crisp bread, or dough for bread, rolls, buns, pizza crust, pretzels, tortillas, pita bread, cakes, cookies, biscuits, crackers, pie crusts, or crisp bread.

It should be understood that this invention is not limited to the exemplary embodiments disclosed herein, and it is intended to cover modifications that are within the spirit and scope of the invention, as defined by the claims.

### DETAILED DESCRIPTION

Other than in the examples herein, or unless otherwise expressly specified, all of the numerical ranges, amounts, values and percentages, such as those for amounts of materials, elemental contents, times and temperatures of reaction, ratios of amounts, and others, in the following portion of the specification and attached claims may be read as if prefaced by the word “about” even though the term “about” may not expressly appear with the value, amount, or range. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, may inherently contain error necessarily resulting from the standard deviation found in its underlying respective testing measurements. Furthermore, when numerical ranges are set forth herein, these ranges are inclusive of the recited range end points (i.e., end points may be used). When percentages by weight are used herein, the numerical values reported are relative to the total weight.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10. The terms “one,” “a,” or “an” as used herein are intended to include “at least one” or “one or more,” unless otherwise indicated.

Any patent, publication, or other disclosure material, in whole or in part, that is said to be incorporated by reference herein in its entirety is incorporated herein only to the extent that the incorporated material does not conflict with existing definitions, statements, or other disclosure material set forth in this disclosure. As such, and to the extent necessary, the disclosure as explicitly set forth herein supersedes any conflicting material said to be incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Described herein are monoglyceride compositions and processes of producing them. The monoglyceride compositions are useful as additives in baked goods, have utility in maintaining a soft crumb during storage, and/or retarding staling. Monoglyceride compositions in fluid form of the present invention are more amenable to pumping and automated metering in automated industrial baking, relative to conventional monoglyceride compositions.

Fully saturated monoglycerides are the effective crumb softeners, and may be solid at room temperature, being powders or beads. As such, they do not disperse easily into the dough, and this lack of dispersion can cause a granular texture in the finished produce. Conventional hydrated monoglycerides are in the form of a paste, and may be more easily dispersed into the dough. However, the conventional pastes require hand scaling, and are not conducive to automation. The monoglyceride compositions of the present invention effective crumb softening, yet disperse easily into food products such as, for example, dough formulations. Such compositions are therefore useful in automated industrial settings.

The term “fluid” indicates that the composition or compound is flowable or pumpable.

In some embodiments, to make the monoglyceride composition of the present invention, water and monoglycerides may be heated. Other water-soluble ingredients, such as organic acids, may be added to the water fraction, and fat-soluble ingredients, such as polysorbate or lecithin, may be added to the monoglyceride fraction. The two fractions may be combined and cooled. The mixture may be milled. Depending on the degree to which the mixture was cooled before milling, the mixture may or may not be cooled further, as required. The mixture may be milled again to produce a thick fluid. Within one day, the fluid product becomes firm, but later returns to a permanent fluid state in about 5 days. Over additional storage time, the fluid monoglyceride composition becomes progressively thinner, as shown below in Example 1.

The mixture may be optionally agitated for a period of time such as, for example, 30 minutes to several hours, which decreases the storage time required for the composition to change to a fluid state.

The amount of water included in the monoglyceride composition may be about 40% to about 90% by weight, in some embodiments may be about 60% to about 85% by weight, and in some embodiments may be about 70% to about 78% by weight.

The term “monoglycerides” as used herein is intended to include compositions having a major portion of monoglycerides. The glyceride compositions may include some diglycerides and may also include some triglycerides.

In some embodiments, the monoglyceride or monoglycerides of the present invention may be distilled, and may contain at least about 85% monoglyceride by weight, and in some embodiments may contain at least 90% monoglyceride by weight. The amount of monoglyceride included in the monoglyceride compositions of the present invention may be between about 0.1% and about 40% by weight, in some embodiments may be between about 12% and about 28% by weight, and in some embodiments may be about 22% to about 24% by weight. In another embodiment, the monoglyceride composition may contain about 20% to about 24% of a distilled monoglyceride that contains at least 90% monoglyceride by weight.

The monoglyceride composition of the present invention also may include an emulsifier.

Emulsifiers that may be used include, but are not limited to, mono- and diglycerides, derivatives of mono- and diglycerides (e.g., DATEMs (diacetyl tartaric acid esters of monoglycerides, ethoxylated mono- and diglycerides, etc.), lecithin, lecithin derivatives (acetylated lecithin, hydroxylated lecithin, enzyme modified lecithin, etc.), fatty acid salts and/or acids of lactylates, polyglycerol esters, propylene glycol monbester, polyglycerol esters, sucrose esters, PGPR (Polyglycerol Polyricinolate), PGME (propylene glycol monoesters), polysorbates, sorbitan esters, sucrose esters and any combinations thereof.

Another emulsifier that may be used is polysorbate 60 (Tween 60). Polysorbates include, but are not limited to, polyoxythylene monostearate, polyoxyethylene sorbitol distearate, polyoxyethylene sorbitan monostearate, polyoxyethylene isosorbide monopalmitate, polyoxyethylene sorbitan distearate, polyoxyethylene isosorbide monooleate, polyoxyethylene sorbitol, trilaurate, polyoxyethylene sorbitan dibehenate, polyoxyethylene isosorbide monolinoleate, polyoxyethylene sorbitan monolaurate, ethoxylated propylene glycol monoesters, polyoxyethylene mannitan monooleate, polyoxyethylene sorbitan monopalmitate, polyoxyethylene sorbitol oleate, as well as other similar ethoxylated fatty acid esters of ethoxylated hexitols, hexitans, isohexides and combinations of any thereof.

In some embodiments, the emulsifier may be included in the monoglyceride composition of the present invention in an amount of about 0.1% to about 10%, in some embodiments may be between about 1.5% and about 6%, and in some embodiments may be about 2% by weight. In one embodiment, the monoglyceride composition may include about 2% polysorbate 60 by weight.

In other embodiments, lecithin and lecithin derivatives may also be included in the monoglyceride compositions of the present invention. In some embodiments, lecithin (or other appropriate emulsifier) may be included in the composition in an amount of about 0.5% to about 10%, may be about 1% to about 5%, in some embodiments may be about 1.5% to about 3%, and in some embodiments may be about 2% by weight.

Non-limiting examples of lecithins which may be used in the present invention include, but are not limited to, those derived from plants such as soybean, rapeseed, sunflower or corn, those derived from animal sources such as egg yolk, and combinations of any thereof.

In one embodiment, the lecithin used in the present invention may be prepared commercially from soybean oil. The lecithin exists preformed in crude soybean oil, and the commercial method of preparation involves precipitation of the lecithin from the oil and subsequent purification. The lecithin may be further processed by bleaching, fractionation, hydrolysis, acetylation, extraction, hydroxylation, and the like. In one embodiment, a standard, modified, fractionated or lyso lecithin derived from soybean oil may be used. Particular reference is made to 21 C.F.R. Section 184.1400 which describes the use conditions for commercial lecithin.

The monoglyceride compositions of the present invention may also contain a microbial growth inhibitor including, but not limited to, an organic acid such as, for example, acetic acid and/or propionic acid. The acids may be present in the range of about 0.1% to about 5% by weight in the monoglyercide composition, in some embodiments from about 0.2% to about 3%, and in some embodiments from about 0.25% each of acetic acid and propionic acid may be included in the fluid monoglyceride composition. Other compounds that may be used as microbial growth inhibitors include, but are not limited to, other organic acids or salts, benzoate compounds, or other food-grade additives to prevent spoilage.

In yet another embodiment, the monoglyceride composition of the present invention may optionally include PGME (propylene glycol monoester), an emulsifier used in baking. About 1% to about 20% PGME by weight may be used in the monoglyceride composition, in some embodiments the PGME may be from about 4% to about 15% and in some embodiments the PGME may be from about 8% to about 12% by weight.

In one process for producing the monoglyceride composition, the water, acetic acid and propionic acid may be combined and heated in a steam jacketed kettle, with mixing. In some embodiments, the mixture may be heated to between about 100° F. to about 200° F., in some embodiments the heat may be between about 160° F. to about 190° F., and in some embodiments the heat may be about 180° F.

In another embodiment, the monoglyceride, polysorbate 60 and lecithin may be combined in a second mixture, and also heated in a steam jacketed kettle, with mixing. In some embodiments, the mixture may be heated to between about 100° F. to about 200° F., in some embodiments the heat may be between about 160° F. to about 190° F., and in other embodiments the heat may be about 175° F.

The two mixtures may be metered individually into a manifold, where they may be combined, pumped through piping to a scraped surface heat exchanger and cooled to between about 90° F. to about 150° F., and in some embodiments cooled to about 130° F. The mixture may be transferred through a colloid mill, in some embodiments operating at about 5000 rpm to about 10,000 rpm, in some embodiments operating at about 6000 to about 8000 rpm, in other embodiments operating at about 7000 rpm. Instead of a colloid mill, an inline mixer, blender and/or pin worker also may be used. The mixture may also be passed through another heat exchanger or other apparatus, where the mixture may be cooled to between about 70° F. to about 110° F., and in some embodiments cooled to about 90° F.

The mixture may be passed through a pin worker operating at between about 100 rpm and 150 rpm, and in some embodiments operating at about 125 rpm. The mixture may be packed off at a temperature of about 80° F. to about 120° F., and in some embodiments packed off at about 95° F. to about 100° F. The product may also be stored at between about 20° F. and about 100° F., in some embodiments stored between about 40° F. and 80° F., in other embodiments stored about 60° F., and in other embodiments stored at about 72° F.

In one embodiment, the mixture may emerges as a fluid, which may become firm after one day, and may soften to a thick fluid in about 5-7 days. The storage time required for the change to fluid form may be accelerated by additional agitation. For instance, the product may optionally be agitated for 30 minutes in a kettle to help accelerate the change in viscosity. Longer or shorter times also may be used.

In the various processes described herein, various types of mixers may be used, including, but not limited to, a votator, a sonolator (inline ultrasonic cavitation homogenizer), a manifold, shear pump, a homogenizer, or a kettle with a mixer, or combinations of any thereof.

For instance, the composition can be produced with an ultrasonic cavitation homogenizer (e.g., Sonolator™; Sonic Corporation, Strafford, Conn. USA)). In such a system, the aqueous ingredients may be provided in one stream, and the monoglyceride provided in another stream. The ingredients can also be heated.

The two streams may be combined through an orifice under pressure into an acoustic resonating chamber in the ultrasonic homogenizer, producing a turbulent jet stream. The pressure can be between 500 psi and 5000 psi. Depending on the machinery and ingredients, it is possible to optimize the manufacturing conditions to produce a monoglyceride composition that is fluid with little or no storage time. In the acoustic chamber, the stream is subjected to cavitational and high sonic and ultrasonic waves and shearing forces, which contribute to the immediate homogenization and reaction of the stream. Examples 5-7 described herein use this method to make the monoglyceride compositions.

Other ingredients also may be included in the monoglyceride composition of the present invention, including, but not limited to, one or more of mono- and diglycerides and other fatty acids, including, but not limited to ethoxylated mono- and diglycerides, sodium and calcium stearoyl lactate, polyglycerol esters, propylene glycol monoester, polyglycerol esters, DATEM (diacetic tartaric acid esters of monoglycerides) esters, sucrose esters, polysorbates, sorbitan esters, and combinations of any thereof.

Other ingredients conventionally used in baking also may be included in the monoglyceride composition, including, but not limited to, enzymes, preservatives, yeast, yeast food, gums and other texturants, fumaric acids, citric acid, starches, sorbic acid, ascorbic acid, antioxidants, and combinations of any thereof.

Such ingredients may be added to the monoglyceride composition for the convenience of the consumer of the monoglyceride composition.

Such ingredients may be added during the process of producing the monoglyceride composition, or may be added to the finished monoglyceride composition.

The monoglyceride composition may be added to baked good formulations alone or in combination with other ingredients. Appropriate baked goods to which the monoglyceride compositions of the present invention may be added include, but are not limited to, bread (including, but not limited to, loaves, rolls, buns, pizza bases, etc.), pretzels, tortillas, pita bread, cakes, cookies, biscuits, crackers, pie crusts, crisp bread, and the like, and the various doughs for the like.

In another embodiment, a monoglyceride composition of the present invention provides aeration and/or foam-building in food products into which it is incorporated. The monoglyceride composition also provides emulsifying properties, better freeze-thaw conditioning, superior complexing of proteins, wetting and dispersion or ingredients, prevents sticking during food processing and manufacturing, and provides dough conditioning. Such foods that may benefit from the monoglyceride composition include, but are not limited to, foods such as, but not limited to, frosting, icings, ice cream, vegetable-based spreads, whipped toppings, margarine, mashed potatoes, beverages and food foams and confections. Other food products, such as oil-based emulsions (e.g., non-dairy coffee creamer) may also benefit from being made by the processes described herein.

According to certain non-limiting embodiments, food compositions produced using the monoglyceride compositions of the present invention may further comprise at least one of dried fruit pieces, a humectant, a fat, a lipid, a colorant, a flavorant, an emulsifier, an acidulant, a sweetener, a vitamin, a mineral, a spice, a soluble fiber, an edible protein powder (e.g., an animal-based protein a plant-based protein), xanthan, nutriceutical ingredients (including but not limited to sterols, isoflavones, lignans, glucosamine, herbal extracts) a preservative and combinations of any thereof. The edible protein powder may comprise any edible protein powder known in the art, including, but not limited to animal-based protein powders selected from a group consisting of milk protein, caseinate, whey protein, buttermilk solids, milk powders, egg protein, gelatin powder, isolates of any thereof, concentrates of any thereof, and combinations of any thereof; and plant based protein powders selected from the group consisting of: soy, canola, pea, wheat, potato, corn, sesame, sunflower, cottonseed, copra, palm kernel, safflower, linseed, peanut, lupin, edible bean, oat, isolates of any thereof, concentrates of any thereof, and combinations of any thereof.

After production, the monoglyceride composition of the present invention is packaged for storage and/or sale. Any of the processes described herein may further include the acts of: placing the composition in a container which may be configured for shipping; associating indicia with the container, such as, for example, placing graphical, written, or numerical indicia on the container, wherein the indicia may be capable of describing the contents of the container, designating the producer of the contents, and/or directing an end user, such as, for example, a food manufacturer, on how to use the composition in the production of a food product; shipping the container containing the composition, wherein any conventional method of shipping may be used, such as, for example, shipping by truck, train, ship, or plane; and combinations of any thereof.

The present invention may be further understood by reference to the following examples. The following examples are merely illustrative of the invention and are not intended to be limiting. Unless otherwise indicated, all parts are by weight.

### EXAMPLES

### Example 1

### Preparation of Monoglyceride Composition

This example describes the production of a fluid monoglyceride composition. The ingredients are provided in Table A, below.

TABLE A
Formulation of a fluid monoglyceride composition.

| Ingredient | Amount (Percent by weight) |
|---|---|
| Water | 73.00% |
| 90% Distilled Monoglyceride (from soy) | 22.50% |
| Polysorbate 60 | 2.00% |
| Lecithin, Bleached Fluid | 2.00% |
| Acetic Acid | 0.25% |
| Propionic Acid | 0.25% |

Procedure and Processing:

1. The water, acetic acid and propionic acid are combined and heated to 180° F. in a steam jacketed kettle while mixing.

2. The 90% distilled monoglyceride, polysorbate 60 and lecithin are combined and heated to 175° F. in a steam jacketed kettle while mixing.

3. The two mixtures are metered individually into a manifold, where the two mixtures are combined, pumped through piping to a scraped surface heat exchanger and cooled to 130° F. In this embodiment, the monoglyceride composition cools upon passage through the scraped surface heat exchanger, and is also mixed as blades of the scraped surface heat exchanger remove the monoglyceride composition from the heat exchanging surfaces of the scraped surface heat exchanger and mix the scraped monoglyceride composition with the remaining portions of the monoglyceride composition within the scraped surface heat exchanger.

4. The mixture goes through a colloid mill operating at 7000 rpm, and through another heat exchanger where the mixture is cooled to 90° F. The colloid mill functions to mill, disperse, homogenize, and/or produce droplets of the monoglycerides and the emulsifier in the monoglyceride composition.

5. The mixture passes through a pin worker operating at 125 rpm and is packed off at 95° F. to 100° F. The pin worker mixes or agitates the monoglyercide composition such that the monoglyceride composition is able to have crystals formed therein, while reducing the size of the crystals.

6. The finished product can optionally be agitated for 30 minutes in a kettle to help accelerate the change in viscosity.

7. The finished product is stored at 72° F. for five or more days.

The process produces a fluid monoglyceride composition, which becomes firm after 1 day, and softens to a thick fluid in 5-7 days, as shown in Table B, below.

TABLE B
Change in viscosity of the fluid monoglyceride
composition after manufacture.

| Days in Storage | Viscosity (in Centipoise) |
|---|---|
| 5 | 67,200 |
| 10 | 25,600 |
| 14 | 11,200 |
| 19 | 6,400 |
| 25 | 1,500 |
| 34 | 1,150 |
| 40 | 975 |

The storage time required for the change of the monoglyceride composition to fluid form can be accelerated by additional agitation, as described in step 6 of the procedure of Example 1. The viscosity values in Table B, above, reflect the product made by the process above, without the additional agitation of step 6.

### Example 2

### Evaluation of Emulsifiers in No-Time Dough White Pan Bread

The monoglyceride composition described herein produced with the procedure of Example 1 was tested against three existing commercial monoglyceride products. The three commercial monoglyceride products included two monoglyceride products in powder form, Panalite 90DK and Panalite 90-03K, commercially available from Archer Daniels Midland company, Decatur, Ill., USA, and a semi-solid monoglyceride, Super Panatex, also commercially available from Archer Daniels Midland company, Decatur, Ill., USA. The test evaluated the effects of the different emulsifiers on finished product characteristics and shelf life (crumb firmness) of no-time dough white pan bread.

The fluid monoglyceride composition and the Super Panatex were superior in performance (according to both qualitative and quantitative measures) to the Panalite 90 DK and the Panalite 90-03. In general, the fluid monoglyceride composition was similar in performance to the semi-solid Super Panatex.

In certain embodiments of the present invention, the specific volumes of loaves baked with the fluid monoglyceride composition were higher than the specific volumes of loaves baked with Super Panatex, but not significantly. The texture readings on days 1 and 7 were statistically the same for the Super Panatex and the fluid monoglyceride composition. However, on day 4, the loaves made with the fluid monoglyceride composition were significantly softer than those made with the Super Panatex. Texture readings are a measure of the crumb softening ability or anti-staling strength of the emulsifier—the lower the texture value, the softer the product.

The four emulsifiers and their usage levels are shown in Table C.

TABLE C
Emulsifiers and levels used in no-time dough white pan bread.

| Emulsifier | Usage Level |
|---|---|
| Panalite 90 DK | 0.5% flour basis |
| Panalite 90-03 PK | 0.5% flour basis |
| Super Panatex | 1.16% flour basis with dough absorption |
| | reduced by 0.62% |
| Fluid monoglyceride | 2.25% flour basis with dough absorption |
| composition | reduced by 1.65% |

No-time dough white pan bread was produced according to the formula and procedure of Table D. The test emulsifiers were added directly to the control formulation. In addition, control product was made with no added emulsifier. Total absorption was reduced for the fluid monoglyceride composition and Super Panatex to compensate for water contained in those two ingredients. All other ingredients included those conventionally used in the commercial production of pan bread.

TABLE D
White Pan Bread No-time Dough Formula.

| Ingredients | Baker's % | Total % |
|---|---|---|
| Flour, bread | 100.0 | 55.0 |
| High fructose corn syrup | 12.7 | 7.0 |
| Salt | 2.0 | 1.1 |
| Shortening (plastic, unemulsified) | 3.0 | 1.7 |
| Calcium propionate | 0.12 | 0.06 |
| Yeast (compressed) | 3.5 | 1.9 |
| Yeast food, acid type | 0.5 | 0.27 |
| Water | Variable* | 33.0 |

*water is estimated at 60% f.b.

Procedure:
Mixer: Hobart A-120 mixer with McDuffee bowl and fork agitator.
Dough: Mix the dough ingredients for 1 minute at speed one.
   Mix again at speed two until optimum gluten development.
   Desired temperature of the dough after mixing is 83° F.±1° F.
Fermentation: Allow the dough to ferment for 30 minutes at 82° F. in a covered container.
Scaling Weight: 524 g (18.5 oz.) per loaf (2 loaves per batch).
Intermediate proof: Allow to rest for 12 minutes at 77° F.
Molder settings: Straight grain.
Gap measurements: Head roll, 0.87 cm ( 3/16″), Sheeter roll, 0.67 cm ( 11/64″), Pressure plate, 3.1 cm, 9″ wide.
Proofing: Place the molded loaves into bread pans and place in proofing cabinet at 110° F., 81.5% Relative Humidity. Allow the dough to rise to ⅝ inches above the top of the pan.
Bake: 20 minutes at 420° F.
Pan Dimensions: Top inside: 10×4¼ inches
   (suggested) Bottom outside: 9½×3¾ inches
   Depth (inside), 2¾ inches

All doughs were produced under controlled conditions in duplicate. Doughs were subjectively evaluated for handling characteristics during mixing and at make-up. Loaves were proofed to height in pans prior to baking. Weights and volumes of the baked breads were measured one hour after baking. Loaves were double wrapped in polyethylene bread bags for storage. Baked breads were subjectively evaluated for external, internal and eating quality characteristics one day after baking.

Crumb firmness was evaluated on days one, four, and seven after baking. Testing was conducted using a TA-XT2 Texture Analyzer to measure grams of force of compression as a measure of crumb firmness.

As summarized in Table E, duplicate doughs made with the fluid monoglyceride composition and Super Panatex scored highest out of the mixer, while all others were downgraded for being elastic. Also, doughs made with the Panalite 90-03 had a granular look and feel, possibly owing to the more granular nature of the Panalite 90-03 and its resistance to dissolution during the nine-minute mixing period. Failure of the powdered monoglyceride formulations to melt at room temperature and disperse properly in the dough can result in a granular texture.

All doughs were judged to be slightly “bucky” at the makeup stage, and would need to be relaxed or stretched to fill the pans sufficiently. This is a not uncommon characteristic of no-time doughs, and to remedy such a situation, most commercial no-time dough formulas contain ingredients that mitigate the processing difficulties inherent in doughs that have had little fermentation.

TABLE E
Characteristics of no-time white pan bread.

| | | | | Total |
|---|---|---|---|---|
| | Dough | External | Internal | Quality |
| Variable | Score | Score | Score | Score |
| Control | 21 | 14.5 | 49.5 | 85 |
| 0.50% 90DK | 21.5 | 14.5 | 51.5 | 87.5 |
| 0.50% 90-03 | 21.5 | 14.5 | 51.5 | 87.5 |
| 2.25% K5016 | 24 | 14 | 54 | 92 |
| 1.16% S. Pan. | 24 | 14 | 53 | 91 |
| Control | 20.5 | 14 | 49.5 | 84 |
| 0.50% 90DK | 22.5 | 14 | 51.5 | 88 |
| 0.50% 90-03 | 22 | 14 | 51.5 | 87.5 |
| 2.25% K5016 | 24 | 15 | 53 | 92 |
| 1.16% S. Pan. | 24 | 14 | 53 | 91 |

Externally, the baked breads scored similarly. All the breads showed signs of slightly weak sidewalls, darker crust color, and wild and bulged break and shred, all functions of the no-time dough system used.

Internally, greater differences were noted in quality between the breads. Grain scores were reasonably good for all samples, with some minor deductions for holes. All the breads scored well for texture, and all but the control and the Panalite 90-03 breads scored well for crumb body, these breads being downgraded for feeling slightly firm on the fingertips. Crumb color was acceptable for all samples, as was taste and aroma. Mouthfeel scores showed some minor differences between the breads, with the control, Panalite 90 DK, and Panalite 90-03 breads feeling slightly firm on the palate. Total scores indicated that the best breads were made with fluid monoglyceride composition of the present invention and Super Panatex.

As summarized in Table F, proof times were in the low 40-minute range for all varieties. Baked loaf weights averaged between 468 and 470 grams, while loaf volumes showed more variation, averaging between 2522 cc and 2656 cc. The loaves containing 0.50% Panalite 90DK had the lowest specific volumes, while the loaves containing 2.25% fluid monoglyceride composition and 1.16% Super Panatex had the highest.

TABLE F
Characteristics of no-time white pan bread.

| | Proof | | | | |
|---|---|---|---|---|---|
| | Height, | Proof | Loaf | Loaf | Specific |
| | mm | Time, | Weight, g | Volume, cc | Volume, |
| Variable | (avg.) | min. | (avg.) | (avg.) | cc/g |
| Control | 93 | 43 | 470.0 | 2700 | 5.38 |
| | 91 | | 467.7 | 2500 | |
| | 90 | | 469.9 | 2500 | |
| | 90 | | 470.3 | 2500 | |
| | 89 | | 470.9 | 2475 | |
| | 90 | | 470.9 | 2475 | |
| | 92 | | 465.7 | 2450 | |
| | 89 | | 468.5 | 2575 | |
| | (91) | | (469.2) | (2522) | |
| 0.50% | 92 | 43 | 469.9 | 2575 | 5.43 |
| Panalite | 90 | | 470.0 | 2550 | |
| 90DK | 91 | | 469.7 | 2650 | |
| | 89 | | 471.3 | 2600 | |
| | 91 | | 469.0 | 2450 | |
| | 90 | | 469.8 | 2550 | |
| | 91 | | 469.8 | 2500 | |
| | 90 | | 470.7 | 2525 | |
| | (91) | | (470.0) | (2550) | |
| 0.50% | 90 | 43 | 471.3 | 2500 | 5.47 |
| Panalite | 91 | | 468.9 | 2700 | |
| 90-03 | 91 | | 469.9 | 2675 | |
| | 92 | | 468.8 | 2450 | |
| | 91 | | 471.2 | 2600 | |
| | 90 | | 470.3 | 2650 | |
| | 90 | | 469.7 | 2500 | |
| | 93 | | 469.4 | 2475 | |
| | (91) | | (469.8) | (2569) | |
| 2.25% Fluid | 90 | 44 | 468.6 | 2700 | 5.65 |
| Monoglyceride | 90 | | 470.2 | 2650 | |
| Composition | 91 | | 470.6 | 2575 | |
| | 91 | | 471.3 | 2650 | |
| | 89 | | 468.7 | 2650 | |
| | 89 | | 470.0 | 2675 | |
| | 92 | | 468.3 | 2675 | |
| | 91 | | 469.7 | 2675 | |
| | (90) | | (469.8) | (2656) | |
| 1.16% Super | 93 | 43 | 470.1 | 2700 | 5.66 |
| Panatex | 92 | | 468.9 | 2625 | |
| | 90 | | 469.0 | 2700 | |
| | 90 | | 467.0 | 2700 | |
| | 91 | | 469.8 | 2575 | |
| | 90 | | 470.3 | 2575 | |
| | 91 | | 469.6 | 2750 | |
| | 91 | | 468.7 | 2600 | |
| | (91) | | (468.9) | (2653) | |
| Control | 93 | 41 | 471.0 | 2575 | 5.55 |
| | 92 | | 468.6 | 2625 | |
| | 91 | | 470.6 | 2600 | |
| | 89 | | 472.0 | 2600 | |
| | 91 | | 470.0 | 2600 | |
| | 89 | | 466.9 | 2475 | |
| | 90 | | 469.0 | 2675 | |
| | 89 | | 467.9 | 2700 | |
| | (91) | | (469.5) | (2606) | |
| 0.50% | 93 | 40 | 469.7 | 2550 | 5.37 |
| Panalite | 92 | | 469.7 | 2500 | |
| 90DK | 91 | | 470.4 | 2550 | |
| | 89 | | 470.3 | 2550 | |
| | 91 | | 470.4 | 2450 | |
| | 89 | | 471.1 | 2525 | |
| | 90 | | 469.0 | 2550 | |
| | 89 | | 472.0 | 2525 | |
| | (91) | | (470.0) | (2525) | |
| 0.50% | 93 | 40 | 467.5 | 2600 | 5.55 |
| Panalite | 90 | | 466.9 | 2600 | |
| 90-03 | 91 | | 469.8 | 2575 | |
| | 91 | | 467.4 | 2425 | |
| | 89 | | 467.8 | 1650 | |
| | 90 | | 469.1 | 2650 | |
| | 91 | | 467.3 | 2675 | |
| | 89 | | 467.9 | 2600 | |
| | (91) | | (468.0) | (2597) | |
| 2.25% Fluid | 92 | 43 | 471.1 | 2600 | 5.60 |
| Monoglyceride | 91 | | 467.8 | 2675 | |
| Composition | 90 | | 468.9 | 2650 | |
| | 89 | | 467.6 | 2650 | |
| | 90 | | 467.7 | 2500 | |
| | 89 | | 468.9 | 2625 | |
| | 93 | | 468.2 | 2600 | |
| | 91 | | 467.8 | 2675 | |
| | (91) | | (468.5) | (2622) | |
| 1.16% Super | 93 | 44 | 468.0 | 2700 | 5.57 |
| Panatex | 93 | | 466.6 | 2700 | |
| | 89 | | 471.8 | 2600 | |
| | 90 | | 466.8 | 2650 | |
| | 90 | | 468.2 | 2575 | |
| | 90 | | 468.0 | 2600 | |
| | 90 | | 467.7 | 2550 | |
| | 91 | | 467.1 | 2500 | |
| | (91) | | (468.0) | (2609) | |

Crumb firming results are summarized in Table G.

TABLE G
Crumb firmness values of no-time white pan bread.

| | Day 1 | | Day 4 | | Day 7 | |
|---|---|---|---|---|---|---|
| | | Std. | | Std. | | Std. |
| Variable | Avg. | Dev. | Avg. | Dev. | Avg. | Dev. |
| Control | 125 | 8 | 229 | 14 | 293 | 17 |
| 0.50% Panalite 90DK | 114 | 8 | 196 | 10 | 233 | 14 |
| 0.50% Panalite 90-03 | 114 | 7 | 205 | 14 | 265 | 27 |
| 2.25% Fluid | 97 | 5 | 156 | 10 | 200 | 8 |
| Monoglyceride | | | | | | |
| Composition | | | | | | |
| 1.16% Super Panatex | 105 | 5 | 170 | 15 | 201 | 12 |
| Control | 120 | 8 | 224 | 19 | 268 | 17 |
| 0.50% Panalite 90DK | 116 | 5 | 197 | 8 | 256 | 14 |
| 0.50% Panalite 90-03 | 117 | 5 | 213 | 15 | 276 | 13 |
| 2.25% Fluid | 107 | 6 | 156 | 7 | 213 | 9 |
| Monoglyceride | | | | | | |
| Composition | | | | | | |
| 1.16% Super Panatex | 106 | 4 | 173 | 9 | 209 | 7 |

The variables of Table G started off with roughly the same firmness on Day 1. As time passed, the samples firmed quickly between Days 1 and 4, and leveled off somewhat between Days 4 and 7. Differences in firmness were greater between the variables at Days 4 and 7. The non-supplemented control bread was the firmest throughout the testing period. Good results were shown by the samples made with 2.25% fluid monoglyceride composition and 1.16% Super Panatex. The other breads fell in between these two breads and the control bread.

All four emulsifiers had a positive effect on dough handling properties and finished bread quality, as evidenced by quality score figures of Table G. Two of the emulsifiers (i.e., the fluid monoglyceride composition and the Super Panatex) showed superiority over the other treatments for baked bread volume and shelf life characteristics.

This example demonstrates that the fluid monoglyceride compositions of the present inventions perform as well in bread production as other emulsifiers, and that such monoglyceride compositions of the present invention can be provided to baked good manufacturers in an easy-to-use fluid form without sacrificing the quality of the baked goods produced.

### Example 3

### Variations in Conditions for Producing the Fluid Monoglyceride Compositions

This example describes process for producing monoglyceride compositions of the present invention. The ingredients may be as provided in Example 1, above.

The processing steps may be as provided in Example 1, above, but certain conditions may be substituted, as indicated in Table H.

TABLE H
Run conditions for additional fluid monoglyceride compositions.

| Conditions | Batch 1 | | Batch 2 | | Batch 3 | | Batch 4 | | Batch 5 | | Batch 6 | |
|---|---|---|---|---|---|---|---|---|---|---|---|---|
| Heat Exchanger (step 3) | 180° | F. | 140° | F. | 100° | F. | 180° | F. | 180° | F. | 140° | F. |
| Heat Exchanger (step 4) | 130° | F. | 107.5° | F. | 85° | F. | 130° | F. | 85° | F. | 107.5° | F. |
| Storage Temp. (step 7) | 40° | F. | 60° | F. | 80° | F. | 80° | F. | 40° | F. | 60° | F. |
| Agitation speed before storage (step 6) | 94 | rpm | 47 | rpm | 94 | rpm | 94 | rpm | 0 | rpm | 47 | rpm |
| Agitation time (step 6) | 0.5 | hrs | 2.25 | hrs | 0.5 | hrs | 4 | hrs | 0.5 | hrs | 2.25 | hrs |

| | | | | | |
|---|---|---|---|---|---|
| Conditions | Batch 7 | Batch 8 | Batch 9 | Batch 10 | Batch 11 |

| | | | | | | | | | | |
|---|---|---|---|---|---|---|---|---|---|---|
| Heat Exchanger (step 3) | 100° | F. | 180° | F. | 140° | F. | 100° | F. | 100° | F. |
| Heat Exchanger (step 4) | 85° | F. | 85° | F. | 107.5° | F. | 130° | F. | 130° | F. |
| Storage Temp. (step 7) | 40° | F. | 80° | F. | 60° | F. | 40° | F. | 80° | F. |
| Agitation speed before storage (step 6) | 94 | rpm | 0 | rpm | 47 | rpm | 0 | rpm | 0 | rpm |
| Agitation time (step 6) | 4 | hrs | 4 | hrs | 2.25 | hrs | 4 | hrs | 0.5 | hrs |

### Example 4

### Preparation of Fluid Monoglyceride Compositions

This example describes other processes for producing fluid monoglyceride compositions. The processing steps may be as provided in Example 1, above.

The amounts of polysorbate, lecithin, acetic acid and propionic acid may be as provided in Example 1, above. However, the water may be varied as disclosed herein, and the source and type of distilled monoglyceride may be varied, as provided in Table I. In Table I, the distilled monoglyceride from soy, as provided in Table A, may be substituted with GMS (monoglyceride from soy), GMP (monoglyceride from palm) and/or PGME (propylene glycol monoester). Monoglyceride from soy contains about 90% glycerol monostearate and 10% glycerol monopalmitate. Monoglyceride from palm contains about 50% glycerol monostearate and 50% glycerol monopalmitate.

TABLE I
Formulations for additional fluid monoglyceride compositions.

| | Composition #1 | Composition #2 | Composition #3 | Composition #4 | Composition #5 |
|---|---|---|---|---|---|
| Ingredient | % of total | % of total | % of total | % of total | % of total |
| Water | 83 | 63 | 63 | 83 | 63 |
| GMS | 0 | 32.5 | 32.5 | 12.5 | 16.25 |
| GMP | 12.5 | 0 | 0 | 0 | 16.25 |
| PGME | 0 | 0 | 0 | 0 | 0 |
| | Composition #6 | Composition #7 | Composition #8 | Composition #9 | Composition #10 |
| Ingredient | % of total | % of total | % of total | % of total | % of total |
| Water | 72.0625 | 63 | 67.5312 | 63 | 83 |
| GMS | 7.1875 | 12.5 | 19.8438 | 0 | 12.5 |
| GMP | 7.1875 | 0 | 3.59375 | 12.5 | 0 |
| PGME | 9.0625 | 20 | 4.53125 | 20 | 0 |
| | Composition #11 | Composition #12 | Composition #13 | Composition #14 | Composition #15 |
| Ingredient | % of total | % of total | % of total | % of total | % of total |
| Water | 83 | 75.5 | 63 | 63 | 67.5312 |
| GMS | 4.16667 | 0 | 16.25 | 11.25 | 3.59375 |
| GMP | 4.16667 | 0 | 16.25 | 11.25 | 19.8438 |
| PGME | 4.16667 | 20 | 0 | 10 | 4.53125 |
| | Composition #16 | Composition #17 | Composition #18 | Composition #19 | Composition #20 |
| Ingredient | % of total | % of total | % of total | % of total | % of total |
| Water | 83 | 83 | 63 | 63 | 72.0625 |
| GMS | 0 | 0 | 0 | 0 | 7.1875 |
| GMP | 12.5 | 0 | 32.5 | 12.5 | 7.1875 |
| PGME | 0 | 12.5 | 0 | 20 | 9.0625 |

| | Composition #21 | Composition #22 | Composition #23 | Composition #24 |
|---|---|---|---|---|
| Ingredient | % of total | % of total | % of total | % of total |
| Water | 73 | 63 | 67.1667 | 63 |
| GMS | 11.25 | 12.5 | 4.16667 | 0 |
| GMP | 11.25 | 0 | 4.16667 | 32.5 |
| PGME | 0 | 20 | 20 | 0 |

### Example 5

### Preparation of Fluid Monoglyceride Composition by Sonolation

This example describes the production of a fluid monoglyceride composition by sonolation. The ingredients are provided in Table J, below.

TABLE J
Ingredients for a fluid monoglyceride composition.

| Ingredient | Amount (Percent by weight) |
|---|---|
| Water | 73.00% |
| 90% Distilled Monoglyceride (from soy) | 22.50% |
| Polysorbate 60 | 2.00% |
| Lecithin, Bleached Fluid | 2.00% |
| Acetic Acid | 0.25% |
| Propionic Acid | 0.25% |

The water, acetic acid and propionic acid were combined at room temperature to form a first mixture. The distilled monoglyceride, polysorbate and lecithin were combined in a second mixture and heated to between about 100° F. and 200° F. The first and second mixtures were directed through an orifice into an acoustic resonating chamber to combine the two mixtures, forming a turbulent jet stream.

The combined stream entered the acoustic chamber, and was subjected to cavitational and high ultrasonic waves and shearing forces, all contributing to immediate homogenization. A sonolator was used to subject the monoglyceride composition to the cavitational force, ultrasonic waves or energy, and shear forces. The two streams of the first mixture and the second mixture were metered separately by positive displacement triplex pumps, which provided an identical pressure to the feed streams as the feed streams were introduced into the sonolator.

The monoglyceride containing (i.e., the second mixture) feed rate was 0.0479 GPM (gallons per minute), and the acidified water (i.e., the first mixture) stream rate was 1.329 GPM, providing a total flow rate of 1.06 GPM. The sonolator pressure was 1000 psi (pounds per square inch). The output stream was of creamy consistency, with a viscosity that was pumpable and changed to a pourable form on storage (Table K).

TABLE K
Change in viscosity of hydrate composition after production.

| Days in storage | Viscosity, cP |
|---|---|
| 7 | 10,000 |
| 15 | 4000 |
| 21 | 2000 |

This shear homogenization of Example 5 reduces the average particle size to mostly less than a micron and forms a very stable dispersion of uniform distribution. The monoglyceride hydrate produced in this Example can be dispersed homogenously into a dough, transforming itself at a faster rate during the baking process into an amylose complexing state, thus providing superior aerating and emulsion stabilizing potential.

### Example 6

### Use of Sonolation to Prepare a Fluid Monoglyceride Composition

This example describes the use of sonolation to produce a monoglyceride composition that is fluid after the sonolation, and does not require any storage time to be fluid. The ingredients are provided in Table L.

TABLE L
Ingredients for a fluid monoglyceride composition.

| Ingredient | Amount (Percent by weight) |
|---|---|
| Water | 73.00% |
| 90% Distilled Monoglyceride (from soy) | 22.50% |
| Polysorbate 60 | 2.00% |
| Lecithin, Bleached Fluid | 1.50% |
| Sodium stearoyl lactylate | 0.50% |
| Acetic Acid | 0.25% |
| Propionic Acid | 0.25% |

The water, acetic acid and propionic acid were combined at room temperature to form a first mixture. The distilled monoglyceride, polysorbate 60, lecithin and sodium stearoyl lactylate were combined and heated to between about 100° F. and 200° F. to form a second mixture. The first and second mixtures were directed through an orifice into an acoustic resonating chamber to combine the two mixtures, thus forming a turbulent jet stream.

The combined stream of the first and second mixtures entered the acoustic chamber, and was subjected to cavitational and high ultrasonic waves and shearing forces, all contributing to immediate homogenization. The two streams (i.e., the first and second mixtures) were metered separately by positive displacement triplex pumps, which provided an identical pressure to the feed streams as the feed streams were introduced into the sonolator.

The monoglyceride (i.e., the second mixture) feed rate was 0.0479 GPM (gallons per minute), and the acidified water (i.e., the first mixture) stream rate was 1.329 GPM, providing a total flow rate of 1.06 GPM. The sonolator pressure was 3000 psi (pounds per square inch). The output stream of the produced monoglyceride composition was a pourable consistency at the time of production. Further changes in the viscosity of the product are shown in Table M.

TABLE M
Change in viscosity of fluid hydrate composition after production.

| Days | Viscosity, cP |
|---|---|
| 7 | 2100 |
| 15 | 1500 |
| 21 | 900 |

This shear homogenization of Example 6 reduces the average particle size to mostly less than a micron and forms a very stable dispersion of uniform distribution. The monoglyceride hydrate produced in this Example can be dispersed homogenously into a dough, transforming itself at a faster rate during the baking process into an amylose-complexing state, thus providing superior aerating and emulsion stabilizing potential.

### Example 7

### Use of Sonolation to Prepare a Gel-Like Monoglyceride Composition

This example describes the use of sonolation to produce a monoglyceride composition that has a gel-like consistency. The ingredients are provided in Table N.

TABLE N
Ingredients for a fluid monoglyceride composition.

| Ingredient | Amount (Percent by weight) |
|---|---|
| Water | 73.00% |
| 90% Distilled Monoglyceride (from soy) | 22.50% |
| Polyglycerol ester | 2.00% |
| Lecithin, Bleached Fluid | 1.50% |
| Sodium stearoyl lactylate | 0.50% |
| Acetic Acid | 0.25% |
| Propionic Acid | 0.25% |

The water, acetic acid and propionic acid were combined at room temperature to form a first mixture. The remaining ingredients were separately combined and heated to between about 100° F. and 200° F. to form a second mixture. The first and second mixtures were directed through an orifice into an acoustic resonating chamber to mix the first and second mixtures, forming a turbulent jet stream.

The combined stream entered the acoustic chamber, and was subjected to cavitational and high ultrasonic waves and shearing forces, all contributing to immediate homogenization. The two streams (i.e., the first and second mixtures) were each metered separately by positive displacement triplex pumps, which provided an identical pressure to the feed streams as the feed streams were introduced into the sonolator.

The monoglyceride (i.e., the second mixture) feed rate was 0.0479 GPM (gallons per minute), and the acidified water (i.e., the first mixture) stream rate was 1.329 GPM, providing a total flow rate of 1.06 GPM. The sonolator pressure was 2000 psi (pounds per square inch). The output stream was of a creamy gel consistency, closer to an alpha-gel in consistency than either a fluid or a paste. The product remains gel like even after three months of storage.

The polyglycerol ester used in the present Examples is an emulsifier that is alpha-tending. That is, an alpha-stable gel comprising monoglycerides and polyglycerol esters can help in direct aeration of the aqueous stage of a food product, and can also stabilize an aqueous foam. The monoglyceride hydrate composition made in this Example was similar in consistency to a conventional alpha gel system. Alpha crystalline monoglycerides in aerated icings and whipped products provide volume, texture and foam stability, and protection against syneresis in freeze-thaw cycles. Such combinations help improve appearance, sheen and, importantly, mouthfeel of low fat icings, also have been shown to have outstanding potential in sweet goods manufacture.

Alpha stable gels of monoglycerides in combination with polyglycerol esters substantially improve the shelf life of food products into which they are incorporated by causing starch to complex the long chain monoglyceride. The polyglycerol esters also provide plasticity, and protect dispersed liquid oil droplets by the formation of a flexible alpha crystalline film around the oil to preserve the foam of a traditional cake batter.

While this invention has been particularly shown and described with references to preferred embodiments thereof, it will be understood by those skilled in the art that various changes in form and details may be made therein without departing from the scope of the invention encompassed by the appended claims.

What is claimed is:

1. A process for producing a monoglyceride composition, the process comprising:
combining water, a monoglyceride and an emulsifier, thus forming a mixture; and
subjecting the mixture to shearing and/or homogenizing, thus producing a monoglyceride composition.

2. The process of claim 1, wherein combining the water, the monoglyceride and the emulsifier comprises:
placing the water in an apparatus;
mixing the monoglyceride with the emulsifier; and
placing the monoglyceride and the emulsifier in the apparatus, thus forming the mixture.

3. The process of claim 2, further comprising an act selected from the group consisting of:
heating the water before placement in the apparatus;
heating the monoglyceride and the emulsifier mixture before placement in the apparatus;
combining a microbial growth inhibitor with the water;
wherein subjecting the mixture to shearing and/or homogenizing takes place in the apparatus and further comprises cooling the mixture;
milling the monoglyceride composition;
agitating the monoglyceride composition while allowing crystals to form in the monoglyceride composition such that a size of the crystals is reduced as compared to allowing the crystals to form in the monoglyceride composition without the agitating;
storing the monoglyceride composition for a period of time such that the monoglyceride composition has a viscosity of 67,200 centipoise or less; and
combinations of any thereof.

4. The process of claim 1, where the shearing and/or homogenizing is done with a scraped-surface heat exchanger.

5. The process of claim 1, where the homogenizing is done with a sonolator.

6. The process of claim 1, where the emulsifier is selected from the group consisting of diglycerides, diacetyl tartaric acid esters of monoglycerides, ethoxylated monoglycerides, ethoxylated diglycerides, lecithin, acetylated lecithin, hydroxylated lecithin, enzyme modified lecithin, fatty acid salts of lactylates, acids of lactylates, polyglycerol esters, propylene glycol monoesters, polyglycerol esters, sucrose esters, polyglycerol polyricinolate, propylene glycol monoesters, polysorbates, sorbitan esters, sodium stearoyl lactylate, and combinations of any thereof.

7. The process of claim 1, further comprising placing the monoglyceride composition in a food product.

8. A product produced by the process of claim 1.

9. A process for producing an emulsifier composition, the process comprising:
mixing water with a an emulsifier selected from the group consisting of monoglycerides, sodium stearoyl lactylate, polysorbate, ethoxylated monoglycerides, diacetyl tartaric acid esters of monoglycerides, polyglycerol esters, propylene glycol monoesters, and any combination thereof, thus forming a mixture; and
subjecting the mixture to ultrasonic energy, thus forming an emulsifier composition.

10. The process of claim 9, further comprising combining a compound selected from the group consisting of a second emulsifier, a microbial growth inhibitor, and a combination thereof with the mixture.

11. The process of claim 9, wherein mixing the water with the emulsifier comprises:
providing the water in a first portion;
providing the emulsifier in a second portion;
heating the second portion; and
combining the first portion with the second portion to form the mixture.

12. The process of claim 10, wherein the second emulsifier is different than the emulsifier and is selected from the group consisting of monoglycerides, diglycerides, diacetyl tartaric acid esters of monoglycerides, ethoxylated monoglycerides, ethoxylated diglycerides, lecithin, acetylated lecithin, hydroxylated lecithin, enzyme modified lecithin, fatty acid salts of lactylates, acids of lactylates, polyglycerol esters, propylene glycol monoesters, polyglycerol esters, sucrose esters, polyglycerol polyricinolate, propylene glycol monoesters, polysorbates, sorbitan esters, sodium stearoyl lactylate, and combinations of any thereof.

13. The process of claim 10, wherein the microbial growth inhibitor is selected from the group consisting of acetic acid, propionic acid, lactic acid, citric acid, a benzoate compound, and combinations of any thereof.

14. A composition comprising:
water; and
a monoglyceride;
wherein the water and the monoglyceride are present in the composition in such amounts to confer a viscosity of 67,200 centipoise or less to the composition.

15. The composition of claim 14, further comprising a compound selected from the group consisting of an emulsifier, a microbial growth inhibitor, and combinations any of thereof.

16. The composition of claim 14, wherein the water and the monoglyceride are present in the composition in such amounts to confer a viscosity of 30,000 centipoise or less to the composition.

17. The composition of claim 14, wherein the water and the monoglyceride are present in the composition in such amounts to confer a viscosity of 10,000 centipoise or less to the composition.

18. The composition of claim 15, wherein the emulsifier is selected from the group consisting of: diglycerides, diacetyl tartaric acid esters of monoglycerides, ethoxylated monoglycerides, ethoxylated diglycerides, lecithin, acetylated lecithin, hydroxylated lecithin, enzyme modified lecithin, fatty acid salts of lactylates, acids of lactylates, polyglycerol esters, propylene glycol monoesters, polyglycerol esters, sucrose esters, polyglycerol polyricinolate, propylene glycol monoesters, polysorbates, sorbitan esters, sodium stearoyl lactylate, and combinations of any thereof.

19. The composition of claim 15, wherein the microbial growth inhibitor is selected from the group consisting of acetic acid, propionic acid, lactic acid, citric acid, a benzoate compound, and combinations of any thereof.

20. A food composition comprising the composition of claim 14.

21. The food composition of claim 20, wherein the food composition is selected from the group consisting of: bread, rolls, buns, pizza crust, pretzels, tortillas, pita bread, cakes, cookies, biscuits, crackers, pie crusts, crisp bread, dough, whipped topping, icing, ice cream, vegetable-based spread, margarine, mashed potatoes, dehydrated potatoes, a beverage, and a non-dairy creamer.

22. A composition comprising:
water;
a monoglyercide;
an emulsifier selected from the group consisting of diglycerides, diacetyl tartaric acid esters of monoglycerides, ethoxylated monoglycerides, ethoxylated diglycerides, lecithin, acetylated lecithin, hydroxylated lecithin, enzyme modified lecithin, fatty acid salts of lactylates, acids of lactylates, polyglycerol esters, propylene glycol monoesters, polyglycerol esters, sucrose esters, polyglycerol polyricinolate, propylene glycol monoesters, polysorbates, sorbitan esters, sodium stearoyl lactylate, and combinations of any thereof; and
a microbial growth inhibitor selected from the group consisting of acetic acid, propionic acid, lactic acid, citric acid, a benzoate compound, and combinations of any thereof;
wherein the water, the monoglyceride, the emulsifier, and the microbial growth inhibitor are present in the composition in such amounts to confer a viscosity of 67,200 centipoise or less to the composition.

23. A food product comprising the composition of claim 22.

24. The food product of claim 23 selected from the group consisting of: bread, rolls, buns, pizza crust, pretzels, tortillas, pita bread, cakes, cookies, biscuits, crackers, pie crusts, crisp bread, dough, whipped topping, icing, ice cream, vegetable-based spread, margarine, mashed potatoes, dehydrated potatoes, a beverage, and a non-dairy creamer.

25. A method of manufacturing a food composition, comprising:
flowing an emulsifier composition comprising an emulsifier selected from the group consisting of monoglycerides, sodium stearoyl lactylate, polysorbate, ethoxylated monoglycerides, diacetyl tartaric acid esters of monoglycerides, polyglycerol esters, propylene glycol monoesters, and any combination thereof, into contact with at least one ingredient of a food composition during a manufacturing process of the food compostion;
wherein the emulsifier composition has a viscosity of 67,200 or less.

26. The process of claim 25, wherein flowing the emulsifier composition comprises pumping the emulsifier composition.

27. The process of claim 25, further comprising metering an amount of the emulsifier composition placed into contact with the at least one ingredient of the food composition.

28-90. (canceled)
